(19) United States
(12) Patent Application Publication
(10) Pub. No.: US 2004/0148562 A1
(43) Pub. Date: Jul. 29, 2004

(54) Methods for the arrangement of a document in a document inventory

(76) Inventor: Hardy Hofer, Paderborn (DE)

Correspondence Address: MORRISON & FOERSTER LLP, 1650 TYSONS BOULEVARD, SUITE 300, MCLEAN, VA, 22102, US

(21) Appl. No.: 10/472,551

(22) PCT Filed: Mar. 22, 2002
(86) PCT No.: PCT/EP02/03275

(30) Foreign Application Priority Data
Mar. 23, 2001 (EP) 01107285.7

(51) Int. Cl. G06F 17/30; G06F 7/00

(52) U.S. Cl. 715/500; 707/3

(57) ABSTRACT

Methods for the arrangement of a new document in an extant document inventory, structured according to arrangement criteria, whereby the closest document to the new document is determined with a minimal difference from the new document with regard to a given scale of difference and the arrangement criteria for the new document are derived from those of the nearest document.

The invention relates to the classification of a document in a document pool.

Larger document pools are generally administered in data processing systems. Search functions that make it possible to find documents on the basis of content-based criteria are a key feature.

A first method consists in assigning catchwords and key words to the documents. By means of Boolean search terms, documents can then be found using these key words. As a result, the assignment of appropriate key words is critical to obtaining good search results. If we interpret the concept broadly, we can certainly conclude that the pool is structured by organizational criteria.

A second method consists in assigning the documents to a hierarchical tree. In a library, a signature that designates such a tree is generally used. However, the occasional user will find the taxonomy of this signature very difficult to comprehend. In other document administration systems, this tree of documents is developed manually, and each node receives a lengthy description. Navigation is possible through a computer program. In both cases, the key issue is that the document pool is structured, in a narrower sense, by organizational criteria.

In all cases, it is of critical importance that the “correct” search words and key words be issued or that the document be assigned to the “correct” position in the tree of documents. The objective of the invention, therefore, is to specify a method,

with which search words and key words and/or a position in the document tree can quickly and easily be found for a new document.

The invention utilizes a system in which a new document is introduced to the system, i.e., the text is transmitted to the system in coded form. Then documents similar to the document are found. For this process, it has proven to be advantageous to determine the distance between the new document and all previous documents. The “cosine measure” in the vector space model is preferably used as the measure of distance. It is described, for example, in “Introduction to Modern Information Retrieval,” by Gerald Salton, McGraw Hill 1983, p. 121-122. Another general description is provided in the thesis titled “Visualisierung latent semantischer Hypertext-Strukturen” [Visualization of Latently Semantic Hypertext Structures] by Hardy Hofer, University of Paderborn, December 1999, in Chapter 4.3.

Once the new document has been compared with the previous document pool using the aforementioned measure of distance, the existing documents that most closely resemble the new document can be indicated by indicating the documents with the smallest distance [from one another] within the sequence of distances.

In a surprisingly simple manner, this results in a solution for classification of a new document. The user is now asked, based on the documents found, to indicate the correct position in the tree, so that the document can then be permanently archived there. Of course, the user's active correction option can be eliminated and the new document can be classified in parallel to the closest document. In a further development, additional heuristic tests are applied in an automatic classification.

On the one hand, the two next documents in the document tree should feature a small distance [from one another]. This distance can, for example, be the minimum number of edges that must be used to pass from one document to the next in the document tree. It is also possible to determine whether additional documents in the same category as the document with the smallest distance exist, and whether one of these documents is positioned very much at the top of the list of similar documents. One condition, for example, could be that if there are at least four documents in the found category, one of these four documents must be among the first four of the most similar documents. These and similar basic conditions must be determined heuristically and specifically to the respective data pool.

Irrespective of the classification in a document tree, the invention can also be used to improve the assignment of catchwords and key words. On the one hand, an automatic assignment of catchwords and key words can already take place prior to analysis of the new document. In the next step, they are offered to the user as suggestions and/or are filed in the system under the heading “determined automatically.” However, it has become evident that although these catchwords that are automatically determined only from the document itself do apply to the document, they do not always permit a targeted search. The catchwords can differ, especially when the terminology operates with other, possibly synonymous, terms. Although dictionaries of synonyms are useful in this regard, they are less effective when used with new fields in which terminology is not yet established.

Therefore, the invention utilizes the catchwords from the document or the closest documents. Once the closest document has been found, as described above, and, in a preferred embodiment, has also been displayed, the search words and key words used therein are also displayed and, in particular, are suggested as search words and key words for the new document.

The user can then modify the list, i.e., delete individual [key words] as irrelevant.

A variant utilizes all search words and key words that were automatically found in the new document and, for example, were found in the four closest documents. These search words and key words are then assigned the number of occurrences, in this case a number between one and five, as a weight, which is also stored in the database. Instead of a fixed limit of four, it is also possible to continue to account for the search words and key words in additional documents in the sequence of their distances [from one another] until the sequence of the search and key words on the list ranked by the number [of occurrences] no longer changes, once a predetermined number of additional documents has been considered.

1. Method of classifying a new document in an existing document pool, which is structured by organizational criteria,
characterized in that
the document is determined to be closest to the new document and has a minimum distance from the new document in terms of a predetermined measure of distance and based on a predetermined selection function,
and the organizational criteria of the new document are derived from the organizational criteria of the closest document.

2. Method according to claim 1, wherein the organizational criteria constitute a tree structure.

3. Method according to claim 1 or 2, wherein the organizational criteria are search and key words.

4. Method according to one of the preceding claims, wherein the selection function is the minimum.

5. Method according to one of the preceding claims, wherein the selection function takes into account the organizational criteria of the related documents.

6. Method according to claim 5, wherein the selection function only takes documents into account in which at least paired identical organizational criteria exist.

7. Method according to claim 6, wherein the selection function, beginning with the first closest document, searches for the next closest document with the same organizational criteria and only takes it into account if the total number of documents having these organizational criteria
is greater than the position of the next closest document in the selection list.
